(19) United States
(12) Patent Application Publication
(10) Pub. No.: US 2006/0158466 A1
(43) Pub. Date: Jul. 20, 2006

(54) Shared pixels rendering display

(75) Inventors: Chin-Wei Chien, Taipei City (TW); Hsiu-Tung Wang, Taipei City (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/036,045

(22) Filed: Jan. 18, 2005

(51) Int. Cl. G09G 5/02

(52) U.S. Cl. 345/694

(57) ABSTRACT

A shared pixels rendering display includes the procedures of taking samples of sub-pixels (r, g, b) of original pixels that mate the pixel layout (R, G, B) of a color filter; determining content variations of neighboring pixels after sampling, and redistributing after a weighted ratio has been applied to the neighboring pixels of the same color; and a driving IC distributing pixel signals after sampling and weighted ratio redistributing to a mating color filter for displaying. By means of the sampling and weighted ratio redistribution, signal channels required for the display area may be reduced. Hence by using human eye vision error, unnecessary image pixels may be reduced, and the number of required driving IC decreases.

### FIELD OF THE INVENTION

The present invention relates to a shared pixels rendering display to provide an image display technique of transforming high resolution to low resolution to reduce the required number of driving IC for the display devices.

### BACKGROUND OF THE INVENTION

Human vision is a sense generated in the brain resulting from light of different wavelengths hitting the retina. Color sense is the basic function in the visual system. It is very important to detect images and physical objects. The wavelength of visible light to human eyes ranges from 390 to 780 nm. There are generally 120 to 180 discernable colors, including seven main colors of purple, blue, cyan, green, yellow, orange and red. Color discerning is the main function of visual cells. As the visual cells concentrate in the center of the retina, it has the most powerful color discerning capability. The discerning power of green, red, yellow and blue gradually decreases from the center of the retina to the periphery.

According to the physics, blending the red, green and blue light properly can generate white light and any color on the spectrum. The color sense principle generally adopts “The theory of three elementary colors”. According to this theory, the retina has three types of conical visual cells or corresponding photo sensing pigment that are especially sensitive to red, green and blue lights. When lights of different wavelengths project to the eye, the sense-enabled wavelength agitates the matched or close visual cells, and a corresponding color sense is generated in the brain. When three visual cells receive same level of agitation, a white color sense is generated.

At present, the flat display device such as the liquid crystal display (LCD) that displays computer or other analog and digital data includes cells consisting of pixels. They are ignited in a certain pattern to form images (characters, numerals, pictures and other graphics).

The cell is the smallest physical unit to form a display unit. The present display device has sub-pixels arranged in stripes (referring to FIG.1). The stripes are laid in a stripe format consisting of sub-pixels r, g, and b to represent respectively red, green and blue colors. In addition, driving IC is the basic element of the LCD, and is the major cost item. The driving IC mainly outputs a required voltage to the pixels to control the turning angle of the liquid crystal molecules.

The color LCD further requires a color filter (CF). Through signal process of a control IC, the white light projected from a back light source can be processed by the color filter to present a color picture. The color filter is formed on a glass substrate by filling organic materials of the three elementary colors of red, green and blue in each r, g and b sub-pixel.

Refer to FIG. 1 for the most commonly used color filter layout. The sub-pixels r, g and b are arranged in stripes to form a high density layout to generate a high resolution image. Take a gate driving IC on the Y axis as an example, for the display panel with an original pixel 10 to meet the high resolution requirement of 240 columns, the sub-pixels r, g and b on each column of the original pixel 10 must have a signal channel in the driving IC. Hence when a driving IC with 240 signal pins is adopted, three driving ICs are needed. For a small LCD that displays fixed graphics or characters, the increased usage of the driving IC results in significant cost increase. Moreover, the soaring demand of the driving IC will result in supply constraint, and the unit cost of the driving IC will become even higher.

### SUMMARY OF THE INVENTION

Therefore the primary object of the present invention is to employ the vision error of human eyes to reduce the pixels used in the image so that by slightly reducing the resolution, the number of driving IC may be reduced, and the cost of the driving IC for the LCD and the required driving IC number become lower.

The present invention provides a shared pixels rendering display in which a driving IC first takes samples from the sub-pixels (r, g, b) of an original pixel. The sub-pixels samples are arranged to mate the pixels (R, G, B) of a color filter. Next, determine content variations of the neighboring pixels after the samples have been taken. Then redistribute according to the weighted ratio with the neighboring pixels of the same color pixels. The driving IC redistributes pixel (R, G, B) signals to a mating color filter for displaying after having finished the samples and weighted ratio. Hence, through the redistribution according to the sampling and weighed ratio, the signal channels required for the pixels (R, G, B) on the display area is reduced. By using the vision error of human eyes, unnecessary image pixels may be reduced. The number of driving IC decreases. Therefore the cost of the driving IC for the LCD and the required number of the driving IC are lower.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional stripe layout.

FIG. 2 is a block diagram of the shared pixels rendering display according to the invention.

FIG. 3 is a schematic view of a first embodiment of pixel sampling according to the invention.

FIG. 4 is a schematic view of a second embodiment of pixel sampling according to the invention.

FIG. 5 is a schematic view of a third embodiment of pixel sampling according to the invention.

FIG. 6 is a schematic view of a fourth embodiment of pixel sampling according to the invention.

FIG. 7 is a schematic view of redistribution according to a weighted ratio of the invention.

### DETAILED DESCRIPTION OF THE PREFERRED EMBODIMENTS

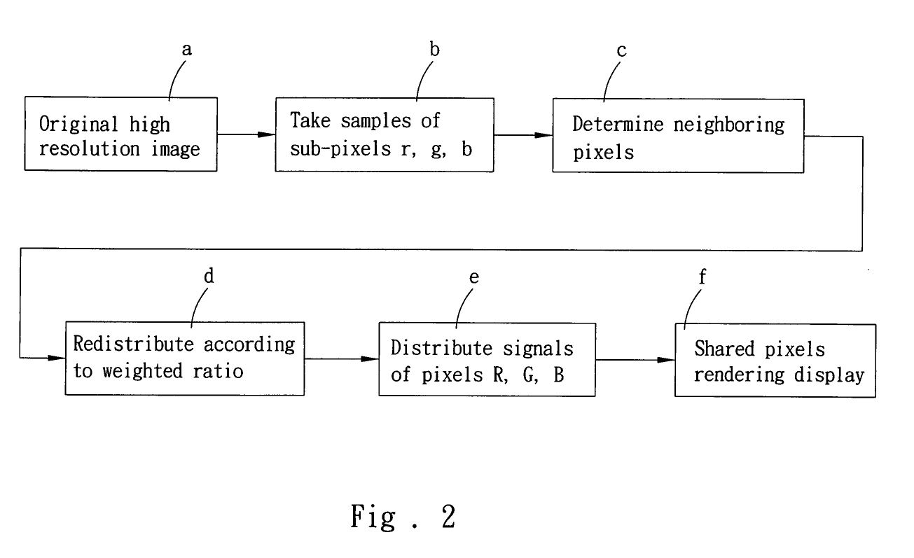

Please refer to FIG. 2 for the shared pixels rendering display of the present invention. The method mainly includes the procedures as follow:

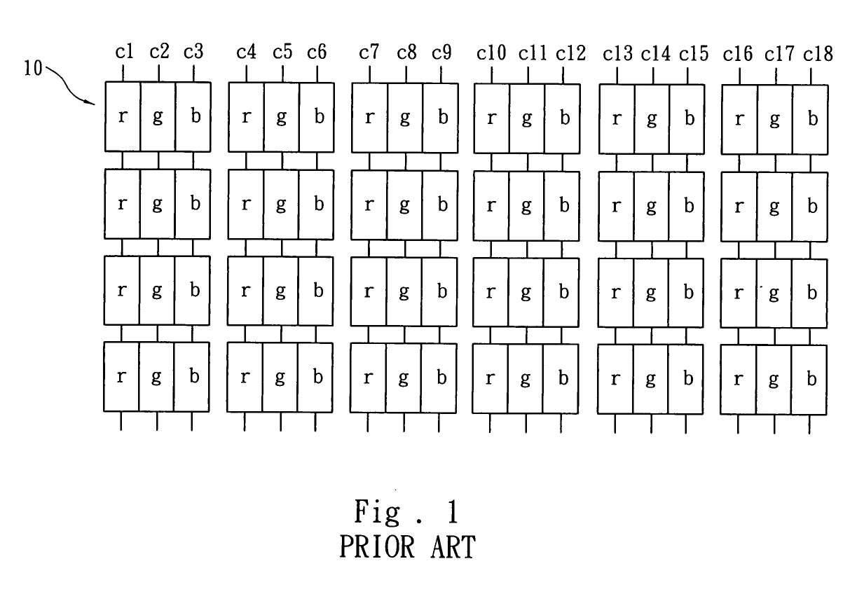

(a) Arrange original pixels 10 of an original high resolution image in a stripe format (also referring to FIG. 1).

(b) The original pixels 10 include sub-pixels r, g and b. Transform the high resolution image to a low resolution image by taking samples of the sub-pixels r, g and b of the original pixels 10 through a driving IC. Sampling of the sub-pixels r, g and b mates R, G and B pixel layout of a color filter.

The rule of sampling is as follow: when the mating display pixel is R on the color filter, the main sample being taken on the original pixel 10 is the sub-pixel r; when the mating display pixel is G on the color filter, the main sample being taken on the original pixel 10 is the sub-pixel g; when the mating display pixel is B on the color filter, the main sample being taken on the original pixel 10 is the sub-pixel b

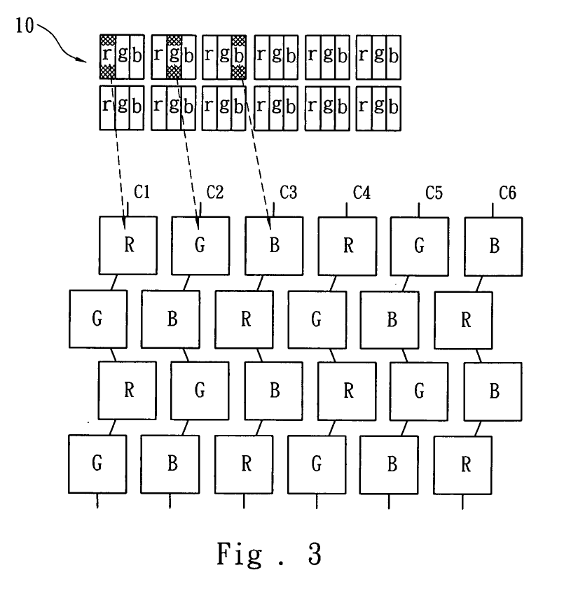

Refer to FIG. 3 for a first embodiment of pixel sampling according to the invention. Retrieve respectively a sub-pixel r, a sub-pixel g, and a sub-pixel b from three original pixels 10 that are arranged in a stripe manner. Place the retrieved sub-pixels respectively on the locations of a mating pixel R, pixel G and pixel B of the color filter. The pixels R, G and B are laid in a triangular manner, namely the pixels R, G and B are stacked in a triangle. In the conventional approach nine channels (c1-c9) are needed to retrieve the sub-pixel r, sub-pixel g, and sub-pixel b from the three original pixels 10, this embodiment needs only three channels (C1-C3).

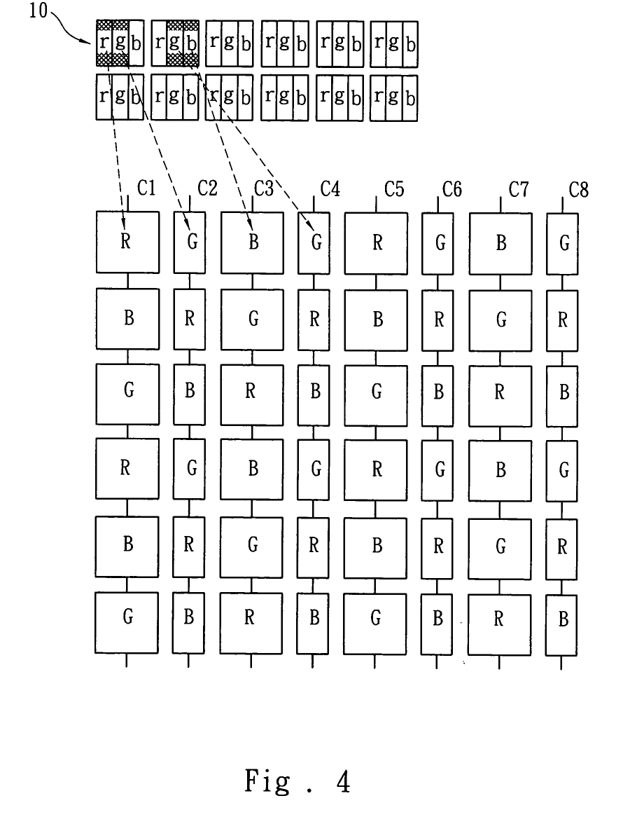

Refer to FIG. 4 for a second embodiment of pixel sampling according to the invention. Retrieve respectively four sub-pixels r, g, g and b from two original pixels 10 that are arranged in a stripe manner. Place the retrieved sub-pixels respectively on the locations of a mating pixel R, pixel G and pixel B of the color filter. The pixels R, G and B are laid in upper, lower, left and right manner with different colors in a stripe fashion. The pixels are laid in stripe by a large width and a small width alternately (at a ratio of 1:2). In the conventional approach six channels (c1-c6) are needed to retrieve the four sub-pixels r, g, and b from two the original pixels 10, this embodiment needs only four channels (C1-C4). According the sampling method of this embodiment, on color number selection for color sense, a portion of luminous points of the pixels R and B are lost. However, all the luminous points of the green light (G) which is less sensitive to human vision are maintained.

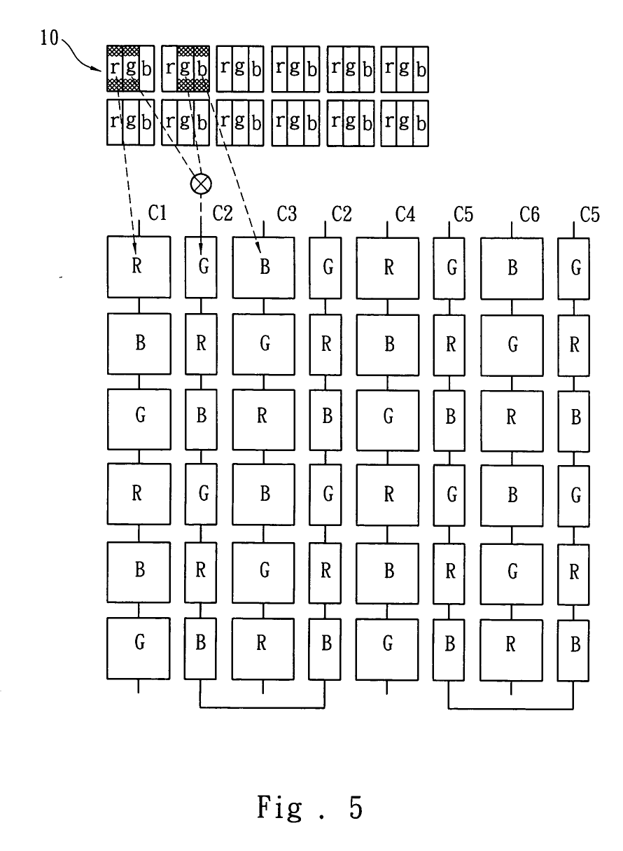

Refer to FIG. 5 for a third embodiment of pixel sampling according to the invention. Retrieve respectively sub-pixels r and b from two original pixels 10 that are arranged in a stripe manner. Place the retrieved sub-pixels respectively on the locations of a mating pixel R and pixel B of the color filter. The two sub-pixels of the original pixel 10 are processed by adding and dividing by two before being placed on the location of mating G-pixel of the color filter. The pixels R, G and B are laid in upper, lower, left and right manner with different colors in a stripe fashion. The pixels are laid in stripe by a large width and a small width alternately (at a ratio of 1:2). It has the same color filter layout as the second embodiment. However the line layout of the display device is different. The two neighboring columns of narrow pixels C2 are coupled in series. In the conventional approach six channels (c1-c6) are needed to retrieve the four sub-pixels r, g, and b from two original pixels 10, this embodiment needs only three channels (C1-C3). According the sampling method of this embodiment, on color number selection for color sense, a portion of luminous points of the pixels R and B are lost. However, all the luminous points of the green light (G) which is less sensitive to human vision are maintained, and mixed and processed for displaying.

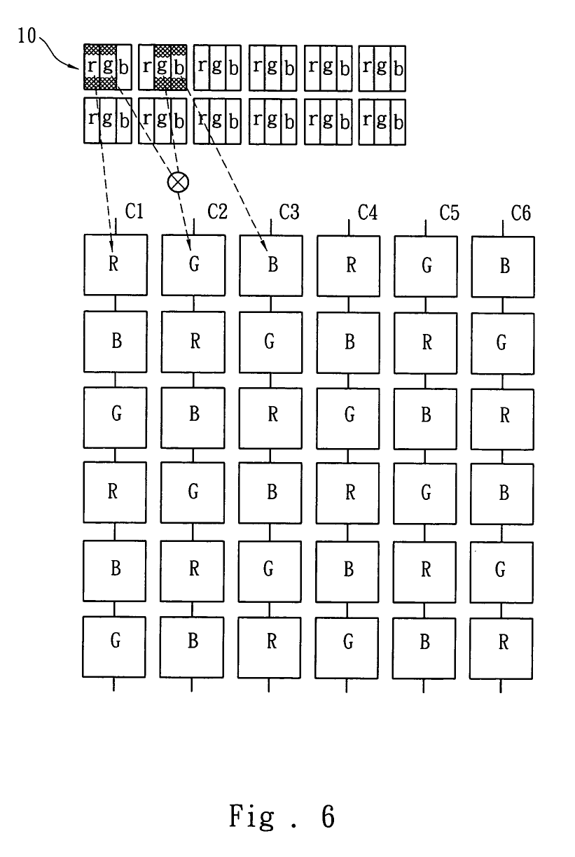

Refer to FIG. 6 for a fourth embodiment of pixel sampling according to the invention. Like the third embodiment previously discussed, retrieve respectively sub-pixels r and b from two original pixels 10 that are arranged in a stripe manner. Place the retrieved sub-pixels respectively on the locations of mating pixel R and pixel B of the color filter. The two sub-pixels of the original pixel 10 are processed by adding and dividing by two before being placed on the location of a mating G-pixel of the color filter. The pixels R, G and B are laid in upper, lower, left and right manner with different colors in a stripe fashion. It differs from the third embodiment by having the same width of pixels for the color filter. In the conventional approach six channels (c1-c6) are needed to retrieve four sub-pixels r, g, and b from the two original pixels 10, this embodiment needs only three channels (C1-C3). According the sampling method of this embodiment, on color number selection for color sense, it is same as the third embodiment. A portion of luminous points of the pixels R and B are lost, but all the luminous points of the green light (G) which is less sensitive to human vision are maintained, and mixed and processed for displaying.

(c) Based on the required displaying applications, the arrangement of the color filter may be selected from one of the four embodiments previously discussed. For instance, the first embodiment can display pictures better than characters. Referring to FIG. 2, after the driving IC has retrieved samples of the sub-pixels r, g and b from the original pixels 10 to mate the color filter, through redistribution of the pixels, the resolution may be reduced. Although the number of channels of the driving IC decreases, a portion of display information also is lost. Depending on loss degree, the color dispersion generated by the new layout also is different. Hence the driving IC has to determine whether the content variation of two neighboring pixels is greater than a set value after the samples were taken. If the content variation is greater than the set value, it means that display information is lost. Then a weighted ratio of the neighboring pixels of the same color is applied to do retribution.

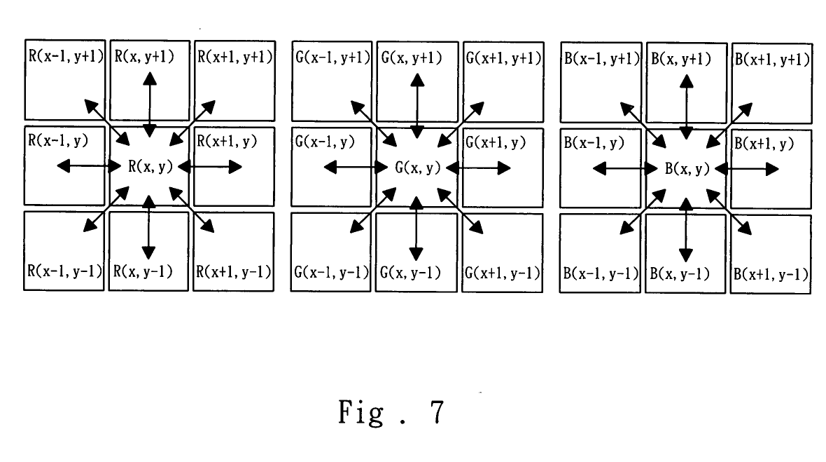

(d) The retribution after applying the weighted ratio is based on the general display and neighboring relationship between the pixels. The lost color element after sampling can be compensated by the neighboring pixels to enhance the display effect. Referring to FIG. 7, a pixel that has a variation after sampling serves as a center pixel R(x,y), G(x,y) or B(x,y), the compensation of the neighboring pixels is done by adding the weighted ratio compensation values of the surrounding pixels of the same color (such as the ones at the coordinates R(x−1,y−1), R(x,y−1), R(x+1,y−1), R(x−1,y), R(x+1,y), R(x−1,y+1), R(x,y+1) and R(x+1,y+1)) to that of the center pixel to become a total of one. Namely, R(x−1,y−1)+R(x,y−1)+R(x+1,y−1)+R(x−1,y) +R(x,y)+R(x+1,y)+R(x−1,y+1)+R(x,y+1)+R(x+1,y+1)=1.

G(x−1,y−1)+G(x,y−1)+G(x+1,y−1)+G(x−1,y)+G(x,y)+G(x+1,y)+G(x−1,y+1)+G(x,y+1)+G(x+1,y+1)=1.

B(x−1,y−1)+B(x,y−1)+B(x+1,y−1)+B(x−1,y)+B(x,y)+B(x+1,y)+B(x−1,y+1)+B(x,y+1)+B(x+1,y+1)=1.

(e) The driving IC distributes the signals of the pixels R, G and B that have been redistributed after sampling and applying the weighted ratio to the mating color filter to serve as luminous signals for displaying the image.

(f) By means of sampling and weighted ratio distribution, the signals of pixels R, G and B are distributed to the mating color filter to do shared pixels rendering display. Thus the required signal channels of the driving IC for the pixels R, G and B on the display area are reduced.

As previously discussed in the embodiments 1 through 4, originally nine channels (c1-c9) are required, by means of the shared pixels rendering display of the invention, only three channels (C1-C3) are needed (first embodiment); or six channels (c1-c6) may be reduced to four channels (C1-C4) (the second embodiment), or three channels (C1-C3) (third and fourth embodiments). With fewer channels, the number of the driving IC also decreases. Thus the required number of the driving IC for liquid crystal display is reduced, and the cost of the driving IC is lower.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A shared pixels rendering display for transforming original pixels of a high resolution image that are arranged in a stripe fashion and contain sub-pixels (r, g, b) to a lower resolution image, comprising the steps of:
retrieving samples of the sub-pixels (r, g, b) by a driving IC to mate a pixel layout (R, G, B) of a color filter;
determining whether content variations of neighboring pixels after the samples have been retrieved being greater than a set value, redistributing the brightness value of the sub-pixels by including weighted ratios in neighboring pixels thereof of the same color when the content variations are greater than the set value;
distributing signals of the redistributing pixels (R, G, B) by the driving IC that have been sampled and applied weighed ratio to the mating color filter for displaying; and
redistributing according to the sampling and weighted ratio to reduce required signal channels for the pixels (R,G,B) on a display area.

2. The shared pixels rendering display of claim 1, wherein the retrieving samples follows a rule by taking the sub-pixel (r) of the original pixels to mate the pixel (R) of the color filter.

3. The shared pixels rendering display of claim 1, wherein the retrieving samples follows a rule by taking the sub-pixel (g) of the original pixels to mate the pixel (G) of the color filter.

4. The shared pixels rendering display of claim 1, wherein the retrieving samples follows a rule by taking the sub-pixel (b) of the original pixels to mate the pixel (B) of the color filter.

5. The shared pixels rendering display of claim 1, wherein the redistribution according to the weighted ratio is based on a center pixel to add compensation values the neighboring pixels of the same color that have applied the weighted ratio to reach a total of one.
